(19) United States
(12) Patent Application Publication
(10) Pub. No.: US 2007/0179842 A1
(43) Pub. Date: Aug. 2, 2007

(54) Method and system to deliver a pixel or block based non-intrusive Internet web advertisement mall service via interactive games using one-time numeric codes

(76) Inventor: Chaing Chen, Laurel, MD (US)

Correspondence Address: Chaing Chen, 8778 Boulder Ridge RD, Laurel, MD, 20723, US

(21) Appl. No.: 11/340,900

(22) Filed: Jan. 27, 2006

(51) Int. Cl. G06Q 30/00

(52) U.S. Cl. 705/14

(57) ABSTRACT

A fully integrated pixel or block based non-intrusive web advertisement mall service system is disclosed. Components of this system include Block Ads Panel, Navigation Panel, Mall Selection Panel, Block JackPot Panel, General Message & Promotion Panel, Block JackPot Award Status Panel, Banner Ads Panel, Sponsor Subscription Panel, and Search Panel. The design philosophy of the web advertisement mall service system is based on the emerging pixel or block advertisement technology in conjunction to the inclusion of Internet interactive games. The purpose of the invention is not only to attract advertisement sponsors, whether they are small or large to use the service, but also to entice web visitors to play games, read ads, and try their luck to win prizes.

### FEDERALLY SPONSORED RESEARCH

Not Applicable

### SEQUENCE LISTING OR PROGRAM

Not Applicable

### FIELD OF THE INVENTION

The present invention relates to a method and system for delivering a pixel or block based non-intrusive and privacy conscientious advertisement mall service over the Internet that encourages users to engage in interactive games, which require the usage of one-time numeric codes. More specifically, the invention describes a method of how to use the web pixel and block technology to maximize the space availability of the web advertisement, a method of how to use a one-time numeric code to interact with the web advertisement for a chance to win a jackpot prize, a method of motivating the one-time numeric code user to read and comprehend the content of the advertisement page through a treasure hunting technique, a method of how to enable advertisement sponsors to subscribe to the advisement service for promoting their product and service, and a method of how to solicit sponsors of all business sizes to effectively utilize the invented advertisement mall service.

### BACKGROUND OF THE INVENTION

The nature of web advertising (ads) is often referred to as banner display advertisements generally placed at the top or side areas of web pages on the Internet. The normal reaction when one encounters such banner ads is to either ignore its presence or click on it with the mouse pointer if the ad seems to offers some attractive information. To attract our attention on such banner ads, the advertiser makes the ads very appealing, such as the use of shinning colors, animated pictures, or persuasive words. To make sure that the ads are effective, the most advanced banner ads also employ a tracking tool embedded on the web site. This advertising tool automatically begins operating once the web page is viewed by the user to covertly monitor the user's web browsing or “surfing” history by analyzing the user's habits and interests based on web sites visited. This tool allows the advertiser to recognize and place ads that will have a better chance of effectively reaching its intended audience based on web surfing habits. As a result, the banner ads displayed as one browses web pages are screened and produced more selectively for that particular user based on this type of monitoring tool. Ultimately, the purpose is to draw attention to an advertiser's information.

To provide an aggressive advertising strategy, some advertisers, especially adult web site operators employ pop-up banner ads. In some instances, a pop-up banner ad is fully automated. Once a user clicks the initial pop-up advertisement, another is automatically created in succession until the complete number of pop-ups in the ad is displayed. Again, the purpose is to draw a user's attention to the advertisement(s). However, this aggressive approach generally creates an unpleasant and intimidating situation for the user. As a result, instead of drawing one's attention to the ad for the purpose of clicking on the banner, the user attempts to either avoid ever browsing that particular web site due to the annoyance, and/or employs pop-up blocker software to prevent this type of occurrence when the web site is viewed. Consequently, the web advertiser has not only reduced its chances of becoming viewed through its pop-ups, but it has also put the content of web site with the banner at jeopardy of becoming viewed itself.

Other web advertising methods are less aggressive using clever tactics to reach a target audience. For example, Google employs a search engine for searching the text of whatever is typed into its search engine and returns not only the search results, but also ads related to the searched text. These ads are usually displayed in text form at the top or right hand side panel on the search results web page. The advertisements in text form do not require the catchy visual effects of a banner to attract the reader. Instead, only the position of the ads at the top or side of the search result is necessary since the reader is already interested and searching for information related to the advertiser's topic. The reader inevitably clicks on the search results at the top assuming it has the most relevance based on the trust of the search engine. This type of search engine has proven to be a successful method of soliciting web advertisers to directly target its intended audience, since placement on a search engine with very high traffic in turn draws high traffic to the advertisement, which in turn drives tremendous ad placement revenue for Google.

The traditional business method for banner advertisers to generate web advertising revenue is to charge sponsor fees based on a per impression or per click. The per impression is measured by the number of days the web advertisement is displayed on the web site. Because there is a space limitation on the advertiser's web page, all ads have to compete for the space availability. Thus, the per impression charges are the result of a time-sharing method of allowing ads to have an orderly usage of a limited advertising space. In general, the per impression is reserved for premium service and is more expensive. On the other hand, the per click does not address the space availability issue. It addresses the effectiveness of the ad itself and measures the number of times an advertisement is actually clicked. The more advertising clicks result in more business opportunity for the advertiser to reach its targeted audience. However, the per click charging scheme is vulnerable to clicking fraud. It is not difficult to execute software code to automatically emulate clicking events. Thus, the per click charging scheme has an inherent risk to be overcome.

Recently, the web advertisement industry appears to have had a revolutionary development. As reported by The Wall Street Journal (Nov. 22, 2005), the success story about a 21-year-old man selling ad spaces on his web site indicates that the web ads do not need to be in a banner form. The web ads can appear as small pixels or blocks. Apparently, these small pixels or blocks are too small to visually indicate the content of the ad. To know the content of the ad, the web visitor has to click the pixel that has a URL link to the pixel ad sponsor's web site. Despite the lack of the apparent ad content information, these pixel ads are able to attract high volume traffic. As a result, a significant improvement of business transactions is reported by the pixel or block ad sponsors. It appears that the pixel or block ads can be a viable method of conducting web advertisements in addition to banner or text URL linked ads.

Since a web page is composed of millions of pixels, the development of pixel advertising has the implication of driving down the costs associated with web advertising. Web ads will be more affordable and ad spaces more available, especially for a small business. Thus, the pixel or block ads have great potential in promoting Internet commerce to a broader level in the future. Thus, the objective of this invention is to explore avenues of employing the emerging pixel or block ad technology for developing a new method of conducting web advertisement placement.

This invention also explores an approach to attract both the web advertiser and the targeted audience while also addressing web browsing privacy issues. First, this invention reflects a viewpoint that the attraction of the web browsing activity is to motivate users who enjoy solving puzzles and are lured by a monetary jackpot or prizes from an Internet game. Second, this invention devises a plan that the jackpot and prizes for the Internet game are derived from a set of sponsored web advertising blocks or pixels that make up the gaming screen. The purpose is to make the jackpot very appealing. Third, this invention mandates a rule that the player logs in anonymously using a one-time numeric code. This anonymous aspect to the game is appealing since the game does not ask for or require personal information to play or monitor the player's activity unlike banner web tracking ads. Some banner advertisers often require the web surfer to supply personal information to receive a product or participate in the advertiser's prize game. The collection of personal information is intrusive, violates the user's privacy, and increases the risk of having your personal information stolen by identity thieves or sold to unchecked third party sources. Finally, this invention suggests that as more web advertisement sponsors subscribe blocks on the game board, the more revenue is generated to supply the jackpot, which in turn attracts more players. Eventually, the block of web advertisements itself becomes attractive to Internet consumers other than gaming players since the block of advertisements will attract all types of interest including: gaming, retail, hobbies, personal services, and others.

### SUMMARY

This invention describes a pixel or block based web advertisement mall service. A pixel is a tiny dot of light and color shown on the screen or the monitor. A block is a small square made of 100 pixels. Unlike the banner ad, the ad using pixels or blocks does not convey any sophisticated ad information directly to the web visitor. The pixel or block is only a simple graphical representation point for the web visitor to click. Because of the pixel or block's small size, an 11×11 inch of digital web page billboard can house a million pixels or 10,000 blocks. This characteristic makes the development of a web advertisement mall possible. This advertisement mall potentially can accommodate 10,000 companies to engage in business activities.

Amassing 10,000 blocks into a 11×11 inch space causes the appearance of the web page to have a graffiti effect cluttered by randomly organized symbols. As a result, this ad space is very diversified and full of surprises. This may be the reason why the www.milliondollarhomepage.com attracts such huge visitor traffic. Furthermore, since more spaces are available, the cost to subscribe an ad is much cheaper than the traditional banner ads since fewer resources are required to support the advertisement on the page. This increase in space gives a small business a very cost effective way to market its products. The success story of the www.milliondollarhomepage.com demonstrates that using pixels or blocks to place a web advertisement is a revolutionary concept. This invention describes the building of a web advertisement mall service based on this concept.

The blocks on the web advertisement mall service will continue to attract and retain the web visitor's attention via interactive games described in this invention. The first level game is a simple lottery game to win a JackPot. To play this game, the visitor must login to the game web site using a one-time numeric code or password. If the one-time numeric code is not available, the system will generate a random one-time code for the user to play the game. Once logged in, the visitor may begin to click the pixel or block ads. After clicking an advertisement, a new window will open to show an advertisement sponsor's page. To encourage the visitor to do more clicking, the system will generate a random number for every clicked web advertisement. If this random number matches the login one-time numeric code JackPot number, then the visitor is eligible to claim the Block JackPot prize. The Block JackPot prize will be given out on a weekly basis. If no one wins the Block JackPot prize, the unclaimed fund will be applied to the next week's Block JackPot. The funding source of the Block JackPot prize is from the subscription fee of the pixel or block ads.

The second level game is to hunt eggs embedded in sponsor's ad pages. To play this game, the visitor needs to signup to get an egg basket in which twenty five random numbers are generated to represent twenty five eggs. Each egg has its own number. The visitor has to find all these eggs from sponsors' pages to be qualified to play a third level game. There is no time limitation to play the egg hunting game. The player can play this game at the convenience of multiple logins to the mall advertisement service as opposed to the JackPot game that is played per each login session. The egg hunt game can be stopped and restarted at any time.

The egg hunting game is designed to give the web visitor or the game player a motivation to read and comprehend a sponsor's ad page in order to find eggs. This can be a very powerful way to deliver ad messages to a potential customer, since this egg hunting game is not intrusive and can be fun to play. It can retain a player's attention and focus for an extended period of time.

To encourage the web mall visitor to do more clicking, the system also randomly gives away bonus eggs which will dramatically increase the chance for the visitor to find all eggs. To find more eggs, the visitor must continue to click more. The design philosophy of developing the web advertisement mall service is hinged on the “clicking”. More clicks can translate to more opportunities for the visitor to view the ad linked by the tiny pixel or block.

The third level game is to play the LuckyEgg. After finding all eggs from the sponsor's page and also those acquired from the bonus egg page, the player is eligible to engage in another level of game for winning a prize. Each egg in the player's egg basket has a prize assigned to it. There are twenty-five prizes in ranking order. At the beginning of the game, the player is offered to win the 13^{th} prize. The player can accept or deny the offer. If denying the offer, the player can open another egg to reveal the prize inside that egg. Once the prize is revealed, the player has lost the chance to win that prize. As each egg of a small prize is opened, the chance to win the larger prize is increased. As a result, the player will be offered a better prize as more egg prizes are revealed and less eggs remain. Once again, the player can accept or deny the offer of each egg during the game. The process keeps going, until all eggs are opened except the last two. If one of the last two eggs is the egg of first prize, the player has 50/50 percent chance to win the first prize. At that moment, the player will be offered a valuable prize. The suspense behind this game will make it fun and exciting to play. Players will diligently seek the egg with the first prize, focus on reading and comprehending the content of the advertisement sponsor's page to find the eggs, and will be motivated to click the ad blocks to win the JackPot.

Playing the egg hunting game may also be in conjunction with playing the game of Sudoku. After finding an egg, the visitor's Sudoku number table will be checked. If there is a match, the matched number will be revealed in the table. Then, the visitor can begin to play the Sudoku game. The level of difficulty to solve the Sudoku number puzzle depends on the initially revealed numbers. This means finding more eggs results in the reduction of difficulty in solving the Sudoku puzzle. Thus, the visitor on the egg hunt has more advantages playing the Sudoku game.

Instead of using 11×11 inches of digital web advertisement billboard, this invention employs an alternate 3×5 inches of billboard. The total number digital billboard blocks in this invention is approximately 1000 blocks. Obvious, the size of the digital billboard of this invention is much smaller than that of the www.milliondollarhomepage.com. To overcome this shortcoming, this invention creates a virtual advertisement mall which provides links to billboards of different categories, such as Book, DVD, Music, Toy, and so on. The home page billboard is for general purpose advertising. All billboard categories share the same egg hunting and LuckyEgg games.

This invention also addresses an automated system for a sponsor to subscribe block ads and eggs for the visitor to play the egg hunting game. The block ads are subscribed on a weekly basis. In contrast, the subscription of the egg can be on an annual or semi-annul basis. Since the ad space availability is no longer an issue, this invention also describes a method to encourage ad sponsors, whether they are large or small, to use all possible ad space and compete for the visibility of the ad based on the supply and demand of blocks.

### BRIEF DESCRIPTION OF THE DRAWINGS

FIG. 1 is a diagram depicting the panel arrangement of the Web Advertisement Mall Service site Home Page.

FIG. 2 is a diagram depicting the Navigation Panel.

FIG. 3 is a diagram depicting the Block JackPot Panel.

FIG. 4 is a diagram depicting the Block Ads Panel.

FIG. 5 is a diagram depicting the Mall Selection Panel.

FIG. 6 is a diagram depicting the General Message & Promotion Panel.

FIG. 7 is a diagram depicting the Block JackPot Award Status Panel.

FIG. 8 is a diagram depicting the Banner Ads Panel.

FIG. 9 is a diagram depicting the Egg Basket used for the EggHunt game.

FIG. 10 is a flowchart showing the process of playing the Block JackPot and EggHunt game.

FIG. 11 is a flowchart showing the process of playing the LuckyEgg game.

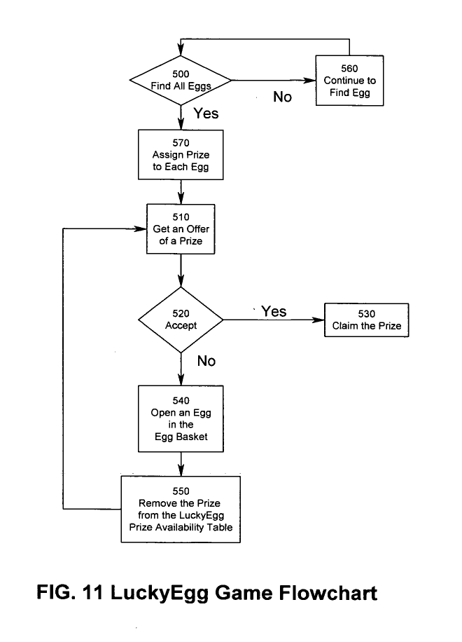

FIG. 12 is a diagram depicting the LuckyEgg Prize Availability Table.

FIG. 13 is a flowchart showing the process of playing the Sudoku game.

### DETAILED DESCRIPTION

Overview of the Web Advertisement Mall Service

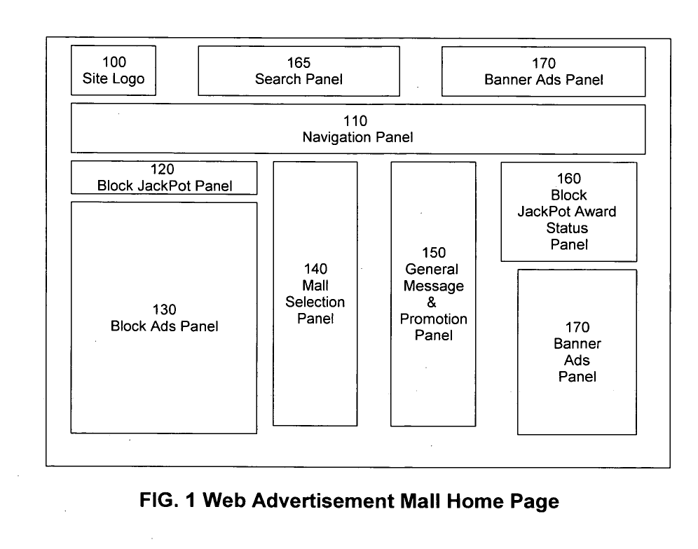

FIG. 1 depicts the web page design for the Home Page of the Web Advertisement Mall Service System, which consists of several panels including: the Navigation Panel 110, Block JackPot Panel 120, Block Ads Panel 130, Mall Selection Panel 140, General Message & Promotion Panel 150, Block JackPot Award Status Panel 160, Search Panel 165, and the traditional Banner Ads Panel 170.

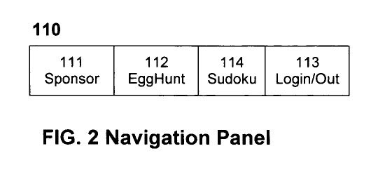

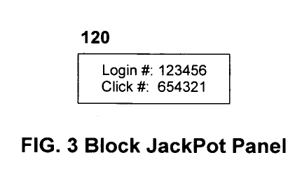

The function of the Navigation Panel 110 as depicted in FIG. 2 is for providing advertisement links to the sponsor's web page 111, the EggHunt game page 112, the Sudoku page 114, and a web site login page 113. FIG. 3 depicts the Block JackPot panel 129, in which the “Login #” represents the one-time numeric number required for login access to the Web Advertisement Mall to play the Block JackPot game. This one-time numeric number can be a one-time password generated by the player using a third party device or a system generated random one-time code transmitted to the player via web page, email, instant message, or short message service over the wireless cell phone, hand-held device, or computer web browser. The “Click #” represents a number which is also randomly generated by the system after the visitor clicks the Block Ads Panel. If the “Click #” matches the “Login #”, the visitor is eligible to win the JackPot prize. The chance to win the Block JackPot prize for each visitor is about 1/1,000,000 per login session.

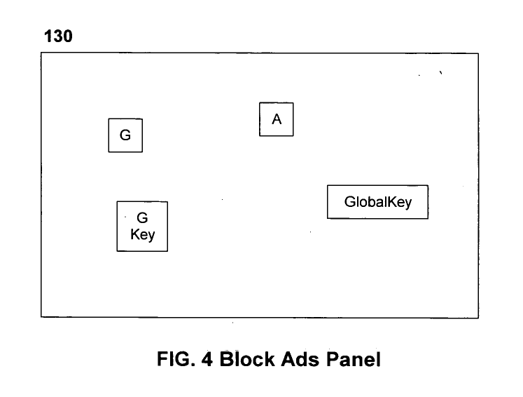

FIG. 4 represents a schematic depiction of a Block Ads Panel 130. The size of each block is approximately ⅛×⅛ inches consisting of 10×10 pixels. The Block Ads Panel is designed to house approximately 1000 blocks in order to make the web advertisement attractive to the viewer without overloading the web advertising information using too many ads that may reduce advertising effectiveness. The sponsor may subscribe ad space per each block unit. Block in plurality means that the ad information may be conveyed to the viewer easily. Thus, the Blocks Ad can serve either small or large businesses. The ad of a single block is intended for the small businesses, and the ad of multiple blocks is intended for larger businesses that can afford greater advertising space. Scalable advertising space through blocks is a characteristic essential for the building of an advertisement digital mall.

To help to deliver more advertisement information, the Web Advertisement Mall Service also uses Javascript, Active X, or AJAX technology to display a message box showing details of the ad when the visitor's mouse moves over the pixel or block located at the Block Ads Panel. This Panel does not operate like a pop-up ad since the message box disappears when the visitor's mouse leaves the ad.

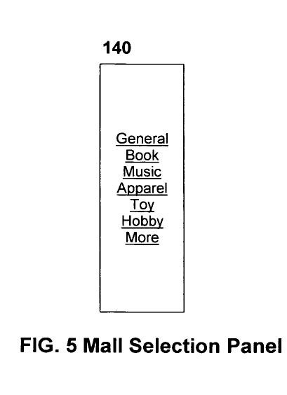

The Mall Selection Panel 140 is depicted by FIG. 5. This panel provides a link to access the Block Ads of different categories that may include: General, Books, Music, Apparel, Toys, Hobby, and others. Each category has it own Block JackPot prize enticing a broad consumer audience to the Web Advertisement Mall instead of just random game players seeking a jackpot. This Mall Selection Panel is scalable for expansion into a variety of categories so the advertising space does not become too limited. Ultimately, the Mall Selection Panel is designed to scale indefinitely so that the ad space availability never becomes an issue.

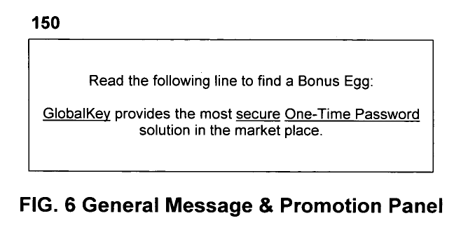

The General Message & Promotion Panel 150 depicted in FIG. 6 is another form of web advertising. It is designed to motivate the viewer into reading web advertising text to locate a bonus egg. In the example as shown in FIG. 6, the bonus egg can be hidden in one of the links represented by the underlined text. The first underline below the “GlobalKey” word links the viewer to the GlobalKey web site. The second underline below “secure” will bring the visitor to the bonus egg page for the viewer to claim the found egg.

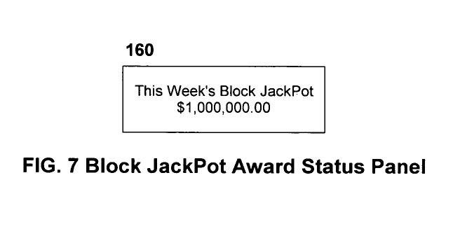

FIG. 7 represents the Block JackPot Award Status Panel 160. The amount of the JackPot is announced in this panel. The Block JackPot is awarded on a weekly basis. If no one claims the Block JackPot, the unclaimed prize will be applied to the next week's Block JackPot. The purpose of this arrangement is to attract viewers to visit this Web Advertisement Mall and increase their playing time due to the incremental jackpot purse. This phenomenon is widely seen in the Powerball Lottery system that increases its jackpot dramatically as it grows rapidly for each consecutive week that no one wins even though the odds of winning do not increase over one week to the next. Only purchasing several thousands of lottery tickets would actually increase the chances of winning only slightly. But the thrill of winning an astronomical jackpot is too appealing in the consciousness of the U.S. consumer. Hence, the Block JackPot Award will potentially grow and increase player interest due to this phenomenon since the odds remain the same week to week and web advertisement revenue will continue to grow the jackpot over time until someone finally wins.

The Search Panel 165 (FIG. 1) provides a search function similar to Google's engine that locates information described on the sponsors' web site. Unlike Google, the Web Advertisement Mall search engine only provides sponsor specific promotions, sales, price comparisons, technical details, product and service information to entice the visitor to engage in business activity.

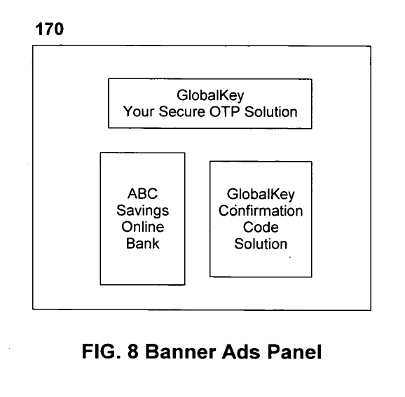

The Web Advertisement Mall Service System also hosts traditional banner ads as shown in FIG. 8. The ad sponsor can subscribe banner ads and have them placed in the Banner Ads Panel 170. This panel is considered premium advertising due to the limited availability of space and size attraction reflecting a premium sponsor subscription rate. The banner ads will automatically track the viewer's web browsing habits in the Blocks Ads panel, develop a viewer profile, and present ads reflecting the interests of the viewer's web browsing habits. This method is similar to the function of banner ads currently in the marketplace to drive advertising to a targeted audience.

The Block JackPot Game

The Block JackPot game is designed as a lottery game. However, the player does not need to purchase a lottery ticket or any item for that matter. The only requirement is that the player must log into the Web Advertisement Mall. The login page displays a disclaimer to notify the game participants of the eligibility requirements, specifically people under the age of 18. The prize for the Block JackPot award comes from the Block Ads sponsors. A certain percentage of proceeds from a sponsor's contribution are distributed to the Block JackPot prize. The Block JackPot can be claimed on a weekly basis. Furthermore, this Block JackPot prize is accumulative, if no one claims the prize during the previous week. The opportunity to win the Block JackPot prize is about 1/1,000,000 per login session. The Block JackPot is an easy game: the player only needs to click the web advertising blocks in the Block Ads Panel to participate. Each click generates a new number and the player may generate as many new numbers per clicks as possible per viewing session to increase the number of chances to win the jackpot.

Whenever the block on the Block Ads panel is clicked by the Block JackPot player, a new window displaying a sponsor's web page will be shown to the player. The player can simply choose to close the window immediately and continue playing the Block JackPot game or view the sponsor's web advertisement and be eligible to participate in another game. This design is meant to discourage players from simply clicking at will to generate as many numbers as possible. The web advertisement game is called the EggHunt and will be described in more detail in the next section. In short, there are eggs embedded in the sponsor's web ads page. The EggHunt player needs to not only view the advertisement, but also carefully read the advertisement to find the egg. The EggHunt player may also be a Block JackPot player and play two games simultaneously. Theoretically, the Web Advertisement Mall Service System can host arrays of games in addition to the EggHunt if necessary based on the principle that the traffic is directed towards the sponsor's web advertisements.

The EggHunt Game

The EggHunt game is designed to retain a player's attention on the sponsor's web advertisement. By hunting for the egg, the player is motivated to read and comprehend the content of the sponsor's web page. The egg is subscribed by the sponsor from the Web Advertisement Mall Service System. The sponsor decides on the egg position that is most suitable to the advertisement and is responsible for embedding the egg into the web page. To motivate a player to begin to reading the page, there is an option to use an egg symbol at the beginning of the page to indicate that the page has an egg.

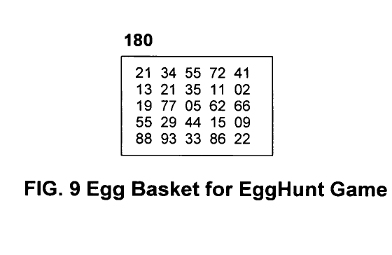

The EggHunt requires a player to register on the Web Advertisement Mall Service System to begin play. After the player registers, an array of eggs are produced and displayed in an egg basket 180 as illustrated in FIG. 9. There are 25 eggs in the basket and each egg has a number assigned to it. The registered EggHunt player manages his personal egg basket in the player's account information page. The EggHunt game may be played at any time since the eggs remain in the basket after each session allowing the player to return and continue to fill the basket. To win the EggHunt game, a player may choose to gather eggs for the basket at anytime since the game has no time or number of login session limitations. The purpose is to find and collect all the eggs from either a sponsor's web advertisement or the system provided bonus egg page.

Once the EggHunt player finds the egg and places it into the basket, the egg will display a new color for each egg collected. If all eggs are found and placed into the basket, then the system will prompt the player to advance to the next game level—the LuckyEgg game.

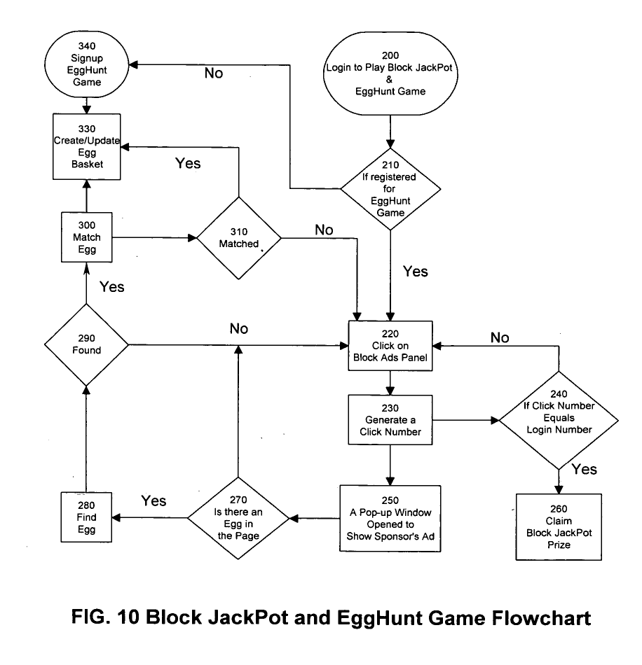

FIG. 10 is a flow chart representing how to play the Block JackPot and EggHunt Games 200. Clicking blocks on the Block Ads Panel 220 generates a click number 230 and opens a pop-up window displaying the web advertisement sponsor's page 250. If the click number becomes equal to the login number 240, then the player can claim the Block JackPot prize 260. To begin to playing the EggHunt game, the player needs to register to play the EggHunt game 340 and login to receive an egg basket 330 and start the egg hunt. If an egg symbol is displayed on a web advertisement pop-up page, then this page signals to the EggHunt player that the web advertisement contains an egg 270. If an egg is found 290, then the system matches 300 that egg with the egg shell displayed in the egg basket. For each new egg placed in the basket, a new color will fill the matching egg shell 330.

The LuckyEgg Game

The FIG. 1 is a flow chart to depict the process of playing the LuckyEgg game. After finding all eggs 500, the EggHunt game player is prompted to play the LuckyEgg game. At this moment, all 25 eggs in the egg basket have a unique randomly assigned prize number 570. The prize number ranges from 01 to 25. The prize 01 represents the grand prize. Each prize is contributed to the EggHunt by the web advertisement sponsor. The prizes are also claimed by the players on a weekly basis, and prizes are accumulative which can be made available from one week to another week if no prize is claimed.

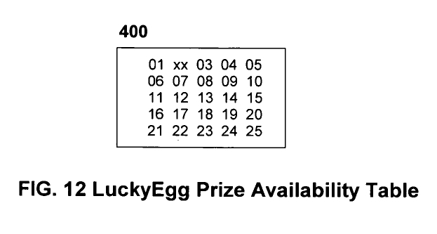

At the beginning of the LuckyEgg game, the player is offered a prize 510, for example a Prize 13 which is a prize between 01 and 25. The offering of this prize means that the player has an equal chance to win the Prize 01 and Prize 25. Thus the offer of the prize is the middle one. The player can choose to accept or deny the offer 520. In case of accepting the offer, the player can claim the prize 530 immediately. To change the player odds to win a better prize, the player can choose deny and click open an egg in the egg basket 540. The opening of the egg from the egg basket will remove or eliminate the available prize 550. For example, if the opened egg has a prize tagged as 02, then Prize 02 will disappear in the LuckyEgg Prize Availability table 400 as shown in FIG. 12. At this time, the player may get an offer of Prize 14, because one of the opportunities of winning the larger prize is gone. The player dramatically increases the chance to win the largest prize from opening many of the smaller prizes.

The LuckyEgg can create a sense of suspension, especially when the last two remaining eggs have a Prize of 01 and 25. The player will then face a situation of having a 50/50 chance to win either the grand prize or the smallest prize. In short, the LuckyEgg game is a game to engage the player in the prize elimination process, which is similar to that seen on TV's “Deal or No Deal” game. This invention modifies the game to add the egg hunting component for encouraging the player to read and comprehend the content of the sponsor's page.

The Sudoku Game

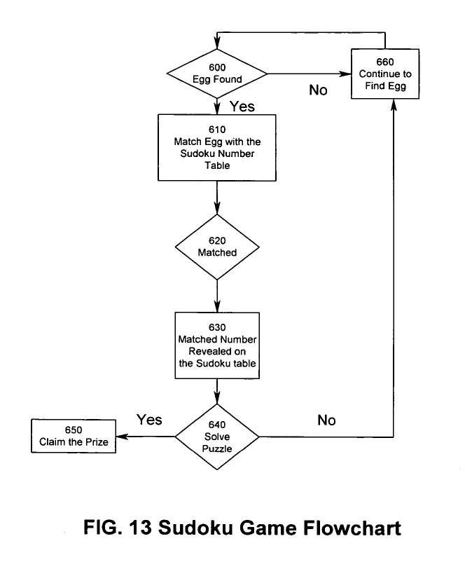

Sudoku is a number puzzle game that has become popular recently. Unlike the crossword puzzle, the Sudoku game can be easily automated and played on the Internet because of the use of numbers. To begin the playing Sudoku, some numbers must be revealed on the Sudoku number table. The more numbers revealed, the easier the game becomes. This invention redesigns the Sudoku game, such that the player has more control on how to play the game in conjunction with playing of the Egg Hunt game. FIG. 13 depicts the flow chart for playing the Sudoku game.

After the player has found the egg 600, the egg number is matched with the Sudoku number table 610. If there is a matching number 620, the matched number is revealed on the Sudoku table 630. At this time, the player can begin to solve the number puzzle 640. If the puzzle is solved, the player can claim a prize 650. If the player can not solve the puzzle, the player may continue to find more eggs 660. This process is repeated until the player is able to solve the puzzle. For an advanced player, the player may not need to find more eggs to solve the puzzle. On the other hand, a beginner may need to find more eggs, such that more numbers are revealed on the table to make the solving of the puzzle easier. Thus, with the combination of the Egg Hunt game, the player has a control on the difficult level of the Sudoku game.

The Revenue Model

The revenue model for the Web Advertisement Mall Service is a mix of donation and a fee based system. A new sponsor can subscribe blocks and eggs based on donation. The Web Advertisement Mall Service will then ask the sponsor to pledge a suggested donation. After the donation is received, the sponsor is scored based on the size of that donation. If the sponsor's score is high due to a high donation, then the quota of subscribing future blocks and eggs is increased and the sponsor has access to premium blocks which will provide the best visibility in the Block Ads Panel. On the other hand, if the sponsor's score is very low, the quota will be reduced to allow the sponsor only to subscribe one block and one egg in the future. The purpose of this arrangement is to give other sponsors, especially small sponsors, a chance for visibility and make the Block Ads Panel a community digital billboard.

All ads shown in the Banner Ads Panel are fee based. The Banner Ads display may depend on the search results of each visitor or player clicking and viewing habits during the Block JackPot and EggHunt games.

The Web Advertisement Mall Service also provides an automated system for sponsors to subscribe blocks and eggs. The subscription of blocks is on a weekly basis, while that for eggs is on an annual or semi-annul basis.

What is claimed is:

1. A method and system to deliver a Web Advertisement Mall Service means which is non-intrusive, privacy conscientious, and fun to play, comprising:
(a) a Block Ads Panel System means as a digital billboard for providing pixel or block ads,
(b) a Navigation Panel System means as a tool for allowing the player to engage in the playing of the interactive games comprising EggHunt, LuckEgg, and Sudoku games,
(c) a Mall Selection Panel System means as a gateway for accessing Block Ads Panel of other merchandise categories,
(d) a Block JackPot Panel System means as the dashboard for allowing the player to play the Block JackPot game,
(e) a General Message & Promotion Panel System means as a promotion tool for enticing the player to engage in the game playing,
(f) a Block JackPot Award Status Panel System means as the announcement board to disclose the size or amount of the Block JackPot that can be claimed,
(g) a Banner Ads Panel System means as the traditional ad space for serving the premium advertisement,
(h) a Sponsor Subscription Panel System means as the tool for ad sponsors to subscribe pixel or block ads and to engage in the game playing to promote sponsors' products and services,
(i) a Search Panel System means as the search engine for the player find bargain items offered by ad sponsors,
whereby a block is the smallest advertisement unit which consists of 100 pixels,
whereby the pixel or block ads in said Block Ads Panel System have an URL link to sponsor's web page,
whereby the player is required to use a one-time numeric login code means to play interactive games comprising Block JackPot, EggHunt, LuckyEgg, and Sudoku games,
whereby the login is anonymous and no personal information is collected,
whereby a random number means is generated by said Web Advertisement Mall Service after the clicking of a pixel or block ad on said Block Ads Panel System by the player,
whereby the player is eligible to win the Block JackPot when said random number equals said one-time numeric code employed or generated during the login procedure,
whereby the Block JackPot prize is awarded on weekly basis,
whereby the Block JackPot prize remains in the pot fund if said Block JackPot prize is not claimed,
where the Block JackPot game is available for every merchandise category listed by said Mall Selection Panel System,
whereby the EggHunt game is an egg hunting process designed to retain the player's attention and to motivate the player to read and comprehend the sponsor's advertisement page.

2. The method and system of claim 1 wherein said Advertisement Mall Service provides means comprising the use of pixel or block advertisement, banner advertisement, and Internet interactive games to advertise and promote sponsor's products and services.

3. The method and system of claim 1 wherein said Web Advertisement Mall Service provides means comprising the use of said Block JackPot, EggHunt, LuckyEgg, and Sudoku interactive games to entice visitors and game players to use said Web Advertisement Mall Service.

4. The method and system of claim 1 wherein said one-time code means comprises one-time password generated by a third party device, or one-time code randomly generated and transmitted by said Web Advertisement Mall Service via means comprising the use of a web page, email, instant messages, or short message service over the wireless cell phone, hand-held device, or computer web browser.

5. The method and system of claim 1 wherein said EggHunt game requires the player to hunt and find for the egg means comprising in a form of tokens, text links, or graphic symbols.

6. The method and system of claim 5 wherein said egg is embedded or hidden in sponsor's advertisement page means.

7. The method and system of claim 6 wherein said sponsor's advertisement page provides means comprising the use of icon, text, or graphic symbol to indicate the existence of said egg hidden in said sponsor's advertisement page.

8. The method and system of claims 1 and 5 wherein said EggHunt game is initialized by the player to create an egg basket means comprising processes to generate, store, and manage a set of randomly generated eggs by said Web Advertisement Mall Service.

9. The method and system of claims 1, 6, and 8 wherein said Web Advertisement Mall Service provides means to match said egg found in said sponsor's advertisement page with eggs stored in said egg basket.

10. The method and system of claim 6 wherein said egg embedded or hidden in said sponsor's advertisement page may contain instant jackpot prize means comprising cash award, sponsor's product or service award, or award for special product promotion purpose.

11. The method and system of claim 1 wherein said LuckyEgg game allows the player of said EggHunt game to engage in a more exciting game playing means comprising the use of the prize elimination process to change the odd of winning the grand prize.

12. The method and system of claim 1 wherein prizes for said Block JackPot, EggHunt, LuckyEgg and Sudoku games are funded from the advertisement fee derived from means comprising the subscription of pixel or block ads used in said Block JackPot game and eggs used in said EggHunt game.

13. The method and system of claim 1 wherein said Web Advertisement Mall Service provides means for advertisement sponsors to subscribe and manage pixel or block ads used in said Block JackPot game and eggs used in said EggHunt game.

14. The method and system of claim 1 wherein said Search Panel System provides means for the web visitor or game player to search sponsor's web site for information comprising product specifications, promotions, sales, price comparisons, or technical details.

15. The method and system of claim 1 wherein said Web Advertisement Mall Service provides means comprising the use of bonus egg to entice the player to engage with the interactive game means comprising the Block JackPot, EggHunt, and Sudoku games.

16. The method and system of claim 1 wherein to prevent the pirate use of the egg, said Web Advertisement Mall Service provides means comprising the use of referrer URL address for the advertisement sponsor to control the use of the subscribed egg.

17. The method and system of claim 1 wherein to encourage advertisement sponsor to subscribe eggs, said Web Advertisement Mall Service provides means comprising the use of the sponsor specific advertisement information displayed on the egg matching page after the egg is found by the player.

18. The method and system of claim 1 wherein said Web Advertisement Mall Service employs a revenue model means comprising a system to encourage ad sponsors, whether they are large or small, to use all possible advertisement space and to compete for the visibility of the advertisement based on the history of their sponsorship level.

19. The method and system of claim 1 wherein said Block Ads Panel System employs means comprising the use of Javascript, Active X, and AJAX technology to display more detailed advertisement information when the visitor's mouse moves over the pixel or block located at the Block Ads Panel.

20. The method and system of claim 1 wherein said Sudoku game is played by means comprising the use of said Egg Hunt game to initiate said Sudoku game, such that the player has a control on the difficult level of said Sudoku game.
